(19) United States
(12) Patent Application Publication
(10) Pub. No.: US 2013/0311899 A1
(43) Pub. Date: Nov. 21, 2013

(54) TECHNIQUES FOR PROVIDING A TOPIC-ORIENTED ONLINE SOCIAL ENVIRONMENT

(71) Applicants: Boubou Guiro, Sausilito, CA (US); Samuel Parker, San Francisco, CA (US)

(72) Inventors: Boubou Guiro, Sausilito, CA (US); Samuel Parker, San Francisco, CA (US)

(73) Assignee: CBS INTERACTIVE, INC., San Francisco, CA (US)

(21) Appl. No.: 13/474,181

(22) Filed: May 17, 2012

(51) Int. Cl. G06F 3/048; G06F 15/16

(52) U.S. Cl. 715/751

(57) ABSTRACT

Techniques to provide a topic-based social environment are disclosed. A topic-based social environment may generate a user account and a user profile. The topic-based social environment may allow a user to follow other users, discussions, content, and specific activities of interest. The environment may retrieve contributions of followed entities according to the user's profile and display the contributions in one user interface. The environment may generate a feed from the retrieved contributions to display to a user. The environment may allow a user to build a profile that is specific to the topic of the community. Other embodiments are described and claimed.

### BACKGROUND

Conventional social networking environments are usually user-centric. A user may follow or subscribe to their interests in the form of other users, groups, organizations, and products, for example. Updates and other contributions from a user's group of interests may be collected and presented to the user in a single location, often referred to as a feed. The interests of a user may span a variety of topic areas, such as friends, charity groups, a corporation that makes products that the user purchases, and so forth. For any given topic, however, the user may not have easy access to all of the information in the community about that particular topic. It is with respect to these and other considerations that the present improvements have been needed.

### BRIEF DESCRIPTION OF THE DRAWINGS

FIG. 1 illustrates an embodiment of a system to provide a topic-based social environment.

FIG. 2 illustrates an embodiment of a second system to provide a topic-based social environment.

FIG. 3 illustrates an embodiment of a third system to provide a topic-based social environment.

FIG. 4 illustrates an embodiment of an social environment.

FIG. 5 illustrates an embodiment of a user interface to identify content to follow.

FIG. 6 illustrates an embodiment of a user interface to provide a feed.

FIG. 7 illustrates an embodiment of a user interface to view a user profile.

FIG. 8 illustrates an embodiment of a centralized system.

FIG. 9 illustrates an embodiment of a distributed system.

FIG. 10 illustrates an embodiment of a logic flow.

FIG. 11 illustrates an embodiment of a computing architecture.

FIG. 12 illustrates an embodiment of a communications architecture.

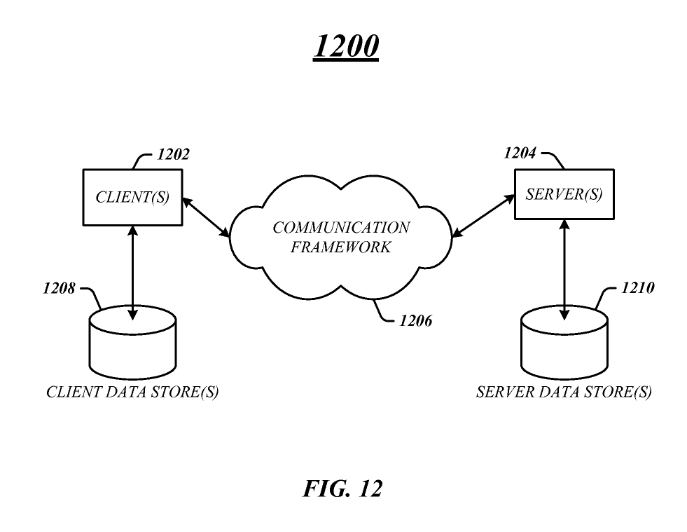

### DETAILED DESCRIPTION

Various embodiments are directed to techniques and apparatuses to provide a topic-based social environment. In an embodiment, a topic-based social environment may generate a user account and a user profile. The topic-based social environment may allow a user to follow other users, discussions, and specific activities of interest. The environment may retrieve content according to the user's profile and display the content in one user interface. The content may be retrieved from sources that the user has not specifically subscribed to. The activities may include, in an embodiment, different items related to the same topic. In one embodiment, for example, the topic may be computer games, and the activities may be specific games and/or gaming platforms. The environment may allow a user to build a profile that is specific to the topic of the community. As a result, the embodiments can provide a unified, integrated social network experience that is topic-based rather than user-based.

With general reference to notations and nomenclature used herein, the detailed descriptions which follow may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

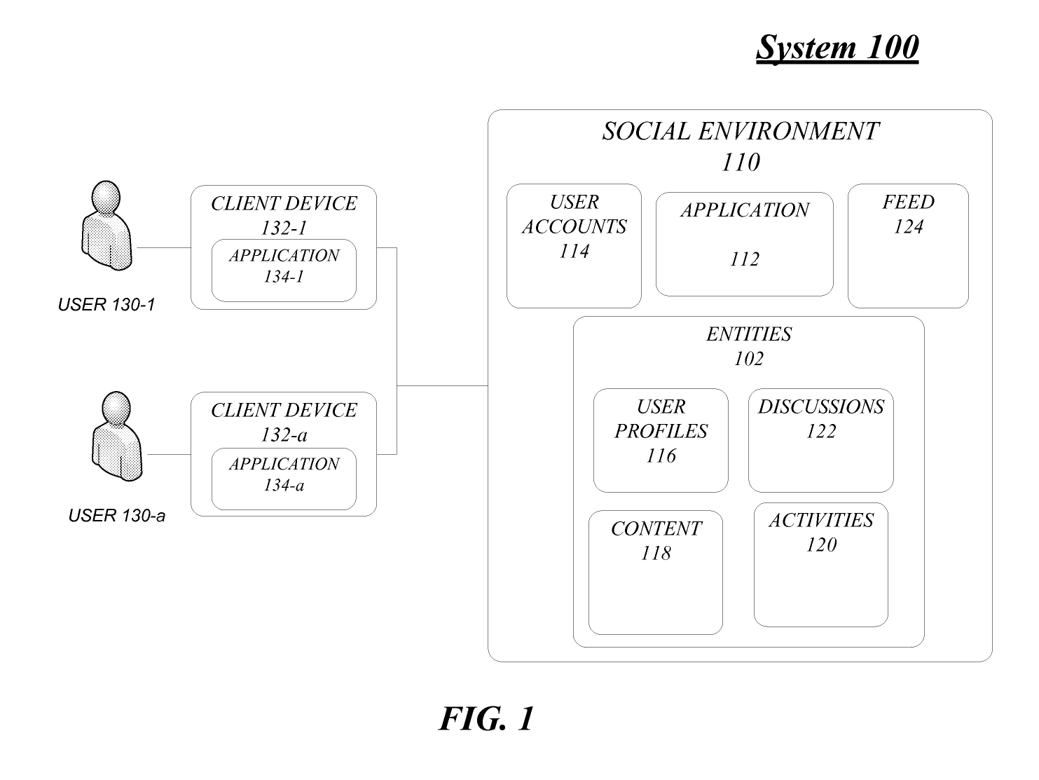

FIG. 1 illustrates a block diagram for a system 100 to provide a topic-based social environment. In one embodiment, the system 100 may comprise a computer-implemented system 100 having an social environment 110 comprising one or more components, such as application 112. System 100 may comprise one or more client devices 132-a, each comprising one or more applications 134-a. Although the system 100 shown in FIG. 1 has a limited number of elements in a certain topology, it may be appreciated that the system 100 may include more or less elements in alternate topologies as desired for a given implementation.

As used herein, “a” and “b” and “c” and similar designators are intended to be variables representing any positive integer. Thus, for example, if an implementation sets a value for a=5, then a complete set of client devices 132-a may include client devices 132-1, 132-2, 132-3, 132-4 and 132-5. The embodiments are not limited in this context.

The system 100 may comprise the social environment 110. The social environment 110 may be generally arranged to provide content, allow registered users to generate content, and provide a community of users centered around a particular topic, such as, but not limited to, computer games, multimedia products, hobbies, sports, or news.

Social environment 110 may be a logical space where users 130 may interact with each other by viewing the contributions of other users, commenting on contributions, sharing contributions, contributing themselves, and so forth. Social environment 110 may be somewhat similar to social networking sites. However, social environment 110 may be based around a particular topic, and have content and contributions that are generally relevant to that topic. Examples of topics may include, but are not limited to, computer games, sports, movies, a specific hobby, an academic field, and so forth. Social environment 110 may be implemented by one or more computers or computing devices, such as servers. The various components of social environment 110 may be stored together on one computing device, or may be distributed among multiple computing devices in communication with each other.

System 100 may include one or more client devices, such as client devices 132-1, 132-a. Client devices 132 may include any wired or wireless computing device capable of communicating with social environment 110 to transmit and receive information. A client device 132 may operate an application 134, which may be a browser, application viewer, or other application program suitable for receiving and displaying information from social environment 110. Examples of suitable web browsers may include, without limitation, Internet Explorer® by Microsoft® Corp., Safari® by Apple Inc., or Chrome® by Google®, among others.

Client devices 132 may also receive and respond to control directives from a user 130 via a suitable graphical user interface (GUI) and various input/output (I/O) devices, such as input from an input device that causes application 134 to connect to a specific website, fill out a form, select GUI elements, follow a hyperlink, and so forth. In general, references herein to a user 130 performing an action related to social environment 110 indicate that a user 130 has given a control directive to client device 132 to cause client device 132 and/or application 134 to exchange information with social environment 110.

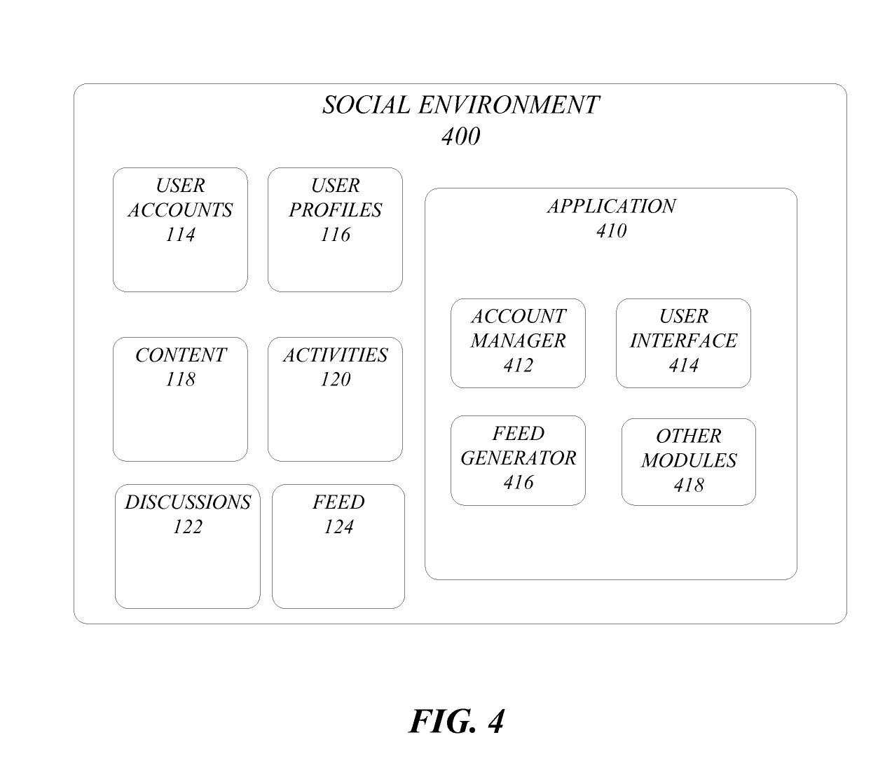

Returning to social environment 110, in various embodiments, online community 110 may include an application 112. Application 112 may perform the functions of providing social environment 110. Application 112 may create user accounts 114 and user profiles 116, and generate feeds 124 for users 130. Application 112 may also generate interfaces that allow users 130 to interact with each other and with social environment 110. Application 112 is discussed in greater detail with respect to FIG. 4.

Social environment 110 may include user accounts 114. A user account 114 may be generated for each user who registers to join social environment 110. A user account 114 may be a way of uniquely identifying a registered user. For example, a user account 114 may include one or more of a user name, a password, a date of birth, an address, an e-mail address, a real name, a security question and answer, and so forth. The information in user account 114 may be, at a minimum, sufficient to ensure that the user account 114 is unique among all user accounts 114. Some or all of the information in user account 114 may be used to authenticate a user who attempts to login to social environment 110.

Social environment 110 may include entities 102 that may be followed by a user 130. Entities may include, for example, other users (represented by user profiles 116), content 118, activities 120 and discussion 122.

Social environment 110 may include user profiles 116. A user profile 116 may include information about the user, the user's contributions, and what the user is following. A user profile 116 may be associated with a user account 114 for the user. In an embodiment, a user profile 116 may be a part of a user account 114. When a user logs in to social environment 110, user profile 116 for that user may be used to retrieve information related to the entities 102 that the user is following. In an embodiment, the retrieved information may be presented as a feed 124 (described further below).

Some or all of a user profile 116 may be visible to other users of social environment 110. In an embodiment, when a first user is not following a second user, only a portion of the second user's profile may be visible to the first user. When the first user is following the second user, more or all of the second user's profile may be visible to the first user. In another embodiment, a user's profile 116 may be visible to any other registered user, regardless of following status, to provide information that can help like-minded users connect with each other in social environment 110.

Social environment 110 may include content 118. Content 118 may include, for example, articles, web log(blog) entries, reviews, descriptive material, video recordings, audio recordings, podcasts, and so forth. Content 118 may be contributed by other users 130, and by other entities 102 within social environment 110. In general, content 118 may be related to the topic of social environment 110. If the topic is computer games, then content 118 may include reviews of games, news about an upcoming release of a new game, blog entries about user experiences with a game, and so forth. If the topic is movies, then content 118 may include movie reviews, plot summaries, previews, news about actors, and so forth. If the topic is sports, then content 118 may include may game highlight videos, commentary about a team or a competition, game summaries, and so forth. The embodiments are not limited to these examples.

Social environment 110 may include activities 120. Activities 120 may include representations of a group of non-user entities 102 that are related to the topic of social environment 110. If the topic is computer games, then activities 120 may include representations of various computer game products and gaming platforms. If the topic is movies, then activities 120 may include representations of various movies, genres of movies, actors, directors, and so forth. If the topic is sports, then activities 120 may include representations of various sports, sports teams, athletes, competition events, and so forth. The embodiments are not limited to these examples.

Social environment 110 may include discussions 122. Discussions 122 may include online conversations between users of social environment 110, for example, in a forum setting. A discussion 122 may begin with an initial post about a subject by one user, typically in, but not limited to, a text format. Other users may respond to the initial post, and to each other's responses, by adding comments. The discussion 122 remains organized according to the initial post. In various embodiments, a forum setting may include several macro-subjects, under which users may begin a discussion about a micro-subject related to the macro-subject. Discussions 122 may generally be relevant to the topic of social environment 110. If the topic is computer games, discussions 118 may be about aspects of computer games, including strategy discussions, general commentary about a game or platform, requests for help about a game or an error, and so forth. If the topic is movies, then discussions 122 may be about movies, comparisons of movies or actors, and so forth. If the topic is sports, then discussions 122 may be about team roster changes, favorite players, comparisons of teams, and so forth.

Social environment 110 may generate a feed 124. A feed 124 may be generated for each registered user of social environment 110. A feed 124 may include contributions from any of the entities 102 that a registered user is following. Whenever an entity 102 contributes to social environment 110, that contribution may appear in the feeds 124 of every user following that contributing entity 102 and in the profile 116 of the contributing entity.

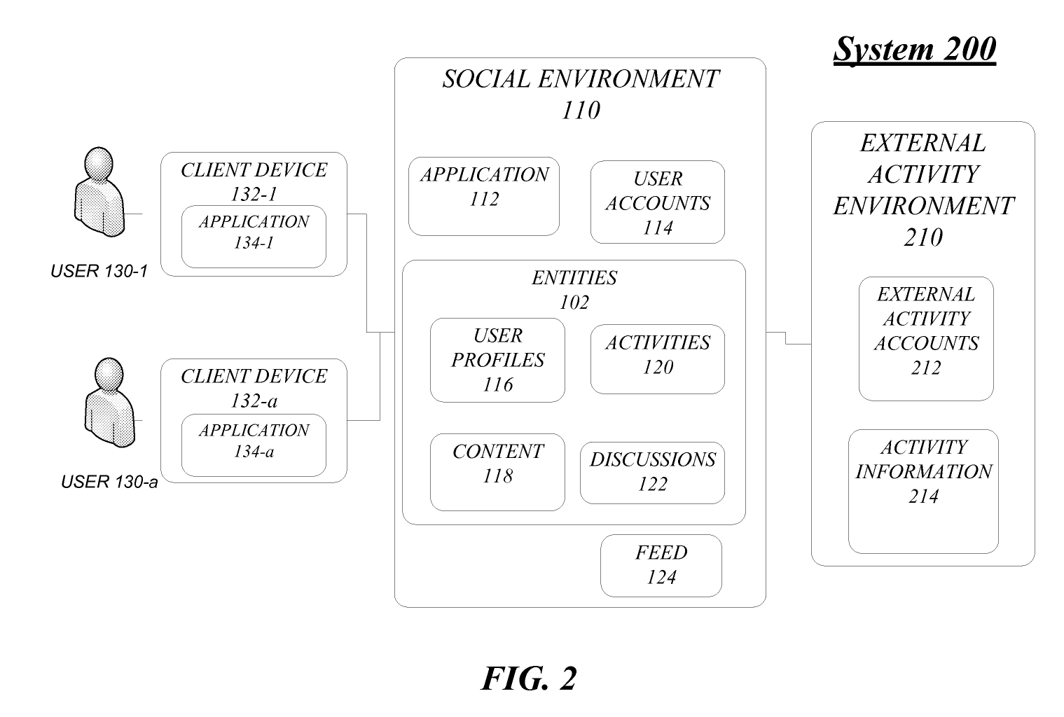

FIG. 2 illustrates an embodiment of system 200. System 200 may be similar to system 100, with the addition of an external activity environment 210. External activity environment 210 may be a separate community of users organized around a specific type of activity. An example of an external activity environment 210 may be a console gaming environment where owners of a particular console game device may register to play networked games on their console game device with other owners of the same type of console game device. In various embodiments, the external activity provided by external activity environment 210 may be related to the topic of social environment 110.

External activity environment 210 may be completely independent from social environment 110, in that external activity environment 210 is owned and operated by an entity different from the entity that owns and operates social environment 110.

External activity environment 210 may be apparently independent from social environment 110, in that external activity environment 210 is owned and operated by the same entity that owns and operates social environment 110, but has distinct network addresses, domain names, and so forth, and so appears to be a separate environment.

External activity environment 210 may include external user accounts 212. External user accounts 212 may include the accounts that members of external activity environment 210 create in order to participate in the activity of external activity environment 210. Similar to user accounts 114, external user accounts 212 may include enough information about a user to uniquely identify the account to external activity environment 210.

External activity environment 210 may include activity information 214. Activity information 214 may include a record of what a user has done within external activity environment 210. In a gaming external activity environment, for example, activity information 214 may include, for a particular user, the games played, statistics of game play, achievements earned during game play, and so forth.

In an embodiment, social environment 110 may allow a user 130 to link an external activity account 212 to a user profile 116 for the user 130. Application 112 may then be able to access activity information 214 and add activity information 214 to a feed 124 for the user 130.

In an embodiment, external activity environment 210 may be a social media environment. Social environment 110 may allow a user 130 to link accounts at social media sites to their user account within social environment 110. This may allow content from the other social media accounts to appear in the user's feed. In some embodiments, a tag or other identifier inserted into the other social media content may be used to indicate when the other social media content should be displayed in the user's feed.

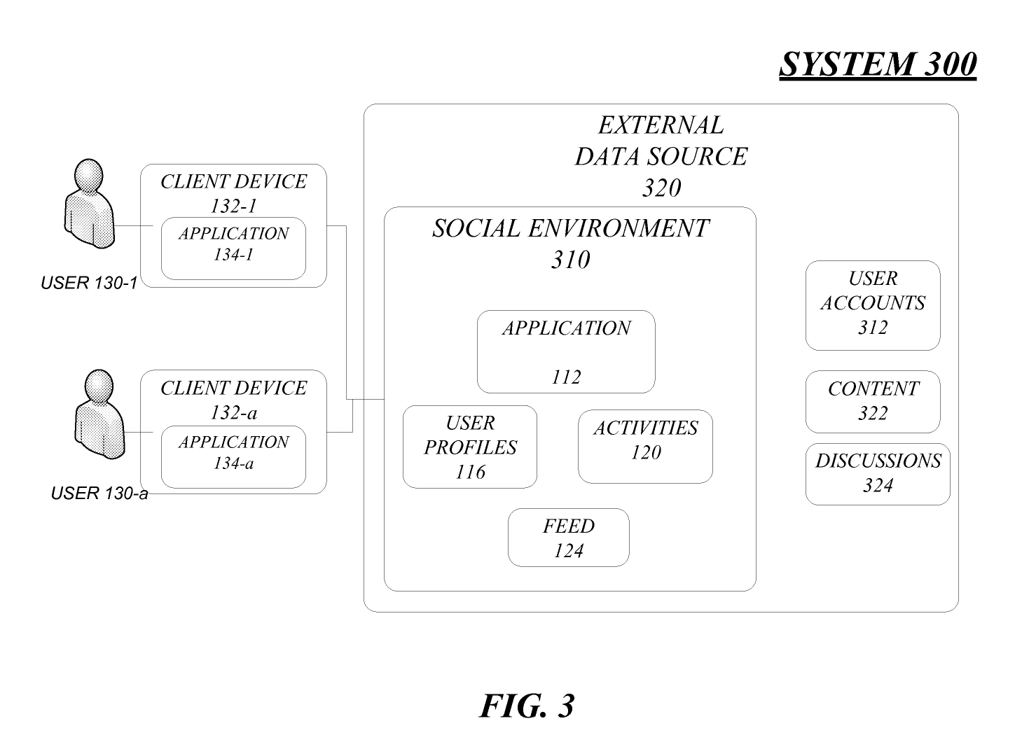

FIG. 3 illustrates an embodiment of system 300. System 300 may provide functionality similar to that of systems 100 or 200, however, with a different organizational structure. System 300 may provide an social environment 310 from within a larger external data source 320. Social environment 310 may be analogous to social environment 110.

External data source 320 may be, for example, a web site that offers content 322 about a topic in various forms to any viewer, regardless of whether a user account exists for the viewer. External data source 320 may be, for example, a news web site, a sports news web site, an entertainment web site, an activity web site, and so forth. Content 322 may include, for example, reviews, news, videos, product support, strategy guides, an online storefront, and so forth. External data source 320 may also provide discussions 324, e.g. forums, where registered users may post about a subject, and comment on another's post.

External data source 320 may have its own user accounts 312. A viewer may register to become a registered user, thereby creating a user account 312. A user account 312 may give a registered user greater access and/or interactions with external data source 320, such as the ability to participate in a forum, or access to exclusive information, for example.

In an embodiment, a registered user of external data source 320 may obtain a user account 114 with social environment 310. In an embodiment, a user's account 312 may be used as the user's account 114. In system 300, all users having a user account 114 also have a user account 312, but the reverse may not necessarily be true.

In system 300, social environment 310 may enhance the user experience with external data source 320 by allowing a user to follow content 322 and discussions 324 from her user profile 116. For example, when a user 130 comments in a discussion 324, that comment may appear in the feed 124 for the user 130. A user 130 may choose to follow an article, for example, in content 322. Comments made about the followed article may then appear on the feed 124 for user 130. The embodiments are not limited to these examples.

FIG. 4 illustrates an embodiment of an social environment 400. Social environment 400 may be a representative example of social environment 110 and/or 310. As shown in FIG. 4, social environment 400 may include an application 410. Application 410 may be a representative example of application 112.

Application 410 may include one or more components or modules to implement its functionality. In an embodiment, for example, application 410 may include an account manager 412, a user interface 414 and a feed generator 416. Additional and/or different components and modules may be used.

Account manager 412 may generate the user accounts 114 by receiving information from a user 130 via client device 132 to uniquely identify the user 130. Account manager 412 may also generate user profiles 116 and link the user accounts 114 to the user profiles 116. Account manager 412 may receive selections made by a user 130 to follow other entities 102, e.g. another user, an activity, content, and/or a discussion, in social environment 400. Account manager 412 may use those received selections to add information about the followed entities 102 to the user profile 116 of the selecting user 130. Information about a followed entity 102 may include, for example, a pointer to the storage location of the followed entity 102, an address of the followed entity 102, a link to the followed entity 102, a reference to the followed entity 102, an identification number of the followed entity 102, and so forth.

User interface 414 may provide one or more interfaces to display content to a user 130 on a client device 132, and to allow a user 130 to interact with social environment 400 via control directives issued to client device 132. User interface 414 may be displayed, for example, as a web page of a web site within a web browser application. User interface 414 may include software instructions, codes, scripts, and so forth (not shown), that generate the structure of a web page into which information from social environment 400 may be inserted.

User interface 414 may provide, for example, a home page for social environment 400 where the user may, at least, log in to the user account. User interface 414 may provide a page to allow a user to find and/or select an entity 102 to follow; a page to display feed 124; a page to allow a user to modify a user profile 116; a page to manage user account 114 settings; and so forth. User interface 414 may also display content 118, activities 120 and discussions 122, and allow a user to interact with the same, for example, by providing a commenting mechanism, a following mechanism, and/or a sharing mechanism. The embodiments are not limited to these examples.

Feed generator 416 may generate a feed 124 for a user 130 based on the user profile 116 for the user. When user interface 414 is displaying a feed page, feed generator 416 may identify the entities 102 that the user is following from the user profile 116. Feed generator 416 may fetch items contributed by the followed entities 102 since that last time feed 124 was generated, and display the contributions on the user's feed 124. Feed generator 416 may arrange the various contributions in some defined order to display. For example, all of the contributions may be displayed in chronological order, with the newest contribution appearing at the front or top of the feed. Feed generator 416 may group contributions according to type, for example, in a tabbed display, where each tab corresponds to a different content type, e.g. a user tab, an activity tab, a discussions tab, and a content tab. The embodiments are not limited to these examples.

For example, for a followed other user, feed generator 416 may retrieve any recently made statements, comments, discussion entries, blog entries, shared items, newly followed items, and so forth. For a followed activity, feed generator 416 may retrieve any posts made by the activity, and content that mentions the activity. For a followed discussion, feed generator 416 may retrieve any contributions to the discussion made since the last time the feed 124 was generated. For a followed content, e.g. an article, feed generator 416 may retrieve comments made about the followed content, articles that reference the followed content, and related articles. The embodiments are not limited to these examples.

Feed generator 416 may update feed 124 periodically. In various embodiments, feed generator 416 may update feed 124 whenever a new contribution is made by one of the user's followed entities 102. In other embodiments, feed generator 416 may update at pre-determined intervals, e.g. every fifteen seconds. In still other embodiments, feed generator 416 may only update feed 124 when requested by the user, for example, through a “refresh” or “update” operation selected by the user.

Application 410 may include other modules 418. Other modules 418 may include other functional components that cause application 410 to present social environment 410 and its components. Other modules 418 may, for example, include scripts that execute when a page is displayed, logic that determines what content is currently popular, and so forth. The embodiments are not limited to these examples.

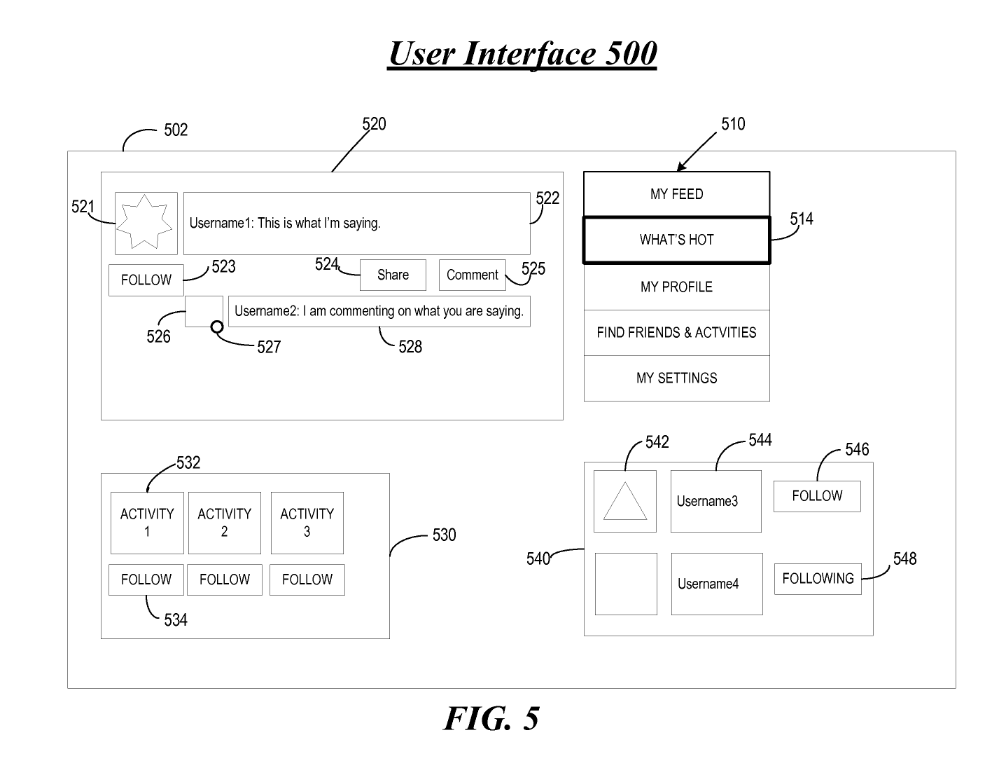

FIG. 5 illustrates an embodiment of a user interface 500 for a “What's Hot” page that allows a user to identify entities 102 to follow. User interface (UI) 500 may be one UI provided by user interface 414. UI 500 may be presented within a window 502, which may be a window generated by application 112, application 134, or within a browser application, for example.

UI 500 may provide a selectable list 510 of pages to view. As shown in FIG. 5, the “What's Hot” page option 514 is selected, and is being displayed in UI 500.

In various embodiments, UI 500 may display current and/or popular contributions to the social environment. UI 500 may display contributions to the community from users and activities that a viewing user may not necessarily be following. In an embodiment, UI 500 may be the first page a newly registered user sees, to facilitate finding entities of interest to follow. In an embodiment, UI 500 may be visible to individuals who have not yet registered with the social environment.

In various embodiments, UI 500 may include a statements pane 520. Statements pane 520 may include contributions, e.g. text statements, made by other registered users. For example, statements pane 520 may include a registered user's avatar 521 and a statement box 522. Statement box 522 may include an identification of the registered user's user name, “Username1” in the current example, as well as the contribution of the registered user. Statements pane 520 may further include a follow button 523, that when selected by a control directive received from a client device, allows the viewing user to follow that registered user. In an embodiment, selection of follow button 523 causes the registered user to be added to the viewing user's profile as a followed user. If the registered user is already being followed by the viewing user, the follow button 523 may display an alternate message, e.g. “Stop Following” or “Following”, and the function of follow button 523 may toggle to cause the viewing user to stop following the registered user, when selected by a control directive.

Statements pane 520 may further provide share button 524 and comment button 525. Share button 524, when selected by a control directive, allows the viewing user to add the statement in statement box 522 to his own feed, effectively sharing the statement with his own followers. Comment button 524, when selected by a control directive, allows the viewing user to write and share a comment on the statement in statement box 522.

A comment made by a registered user, after selecting comment button 524, may appear in a comment box 528, along with the commenting user's name, e.g. Username2 in the illustrated example. Additionally, the avatar 526 for the commenting user may be displayed next to comment box 528. In an embodiment, a follow switch 527 may be displayed on avatar 526 to allow the viewing user to follow, or stop following, the commenting user. Selecting follow switch 527 may cause the viewing user to start following the commenting user. Follow switch 527 may change visually to indicate the change from a “not following” state to a “following” state for the viewing user.

In various embodiments, UI 500 may include an activities pane 530. Activities pane 530 may display a visual representation 532, e.g. an icon, logo, avatar and so forth, for one or more activities that are new and/or popular within the social environment. Each visual representation 532 of an activity may have a follow button 534 displayed next to it, and associated with the activity, that allows a viewing user to begin following the activity.

In various embodiments, UI 500 may include a users pane 540. Users pane 540 may display, for example, some of the most actively participating registered users of the social environment and/or those who have the most followers. Users pane 540 may display, for example, an avatar 542 and a user name 544 for a particular user. If the user is not being followed by the viewing user, then a follow button 546 may be displayed next to the user name 544. If the user is already being followed by the viewing user, then a following button 548 may be displayed next to the user name 544.

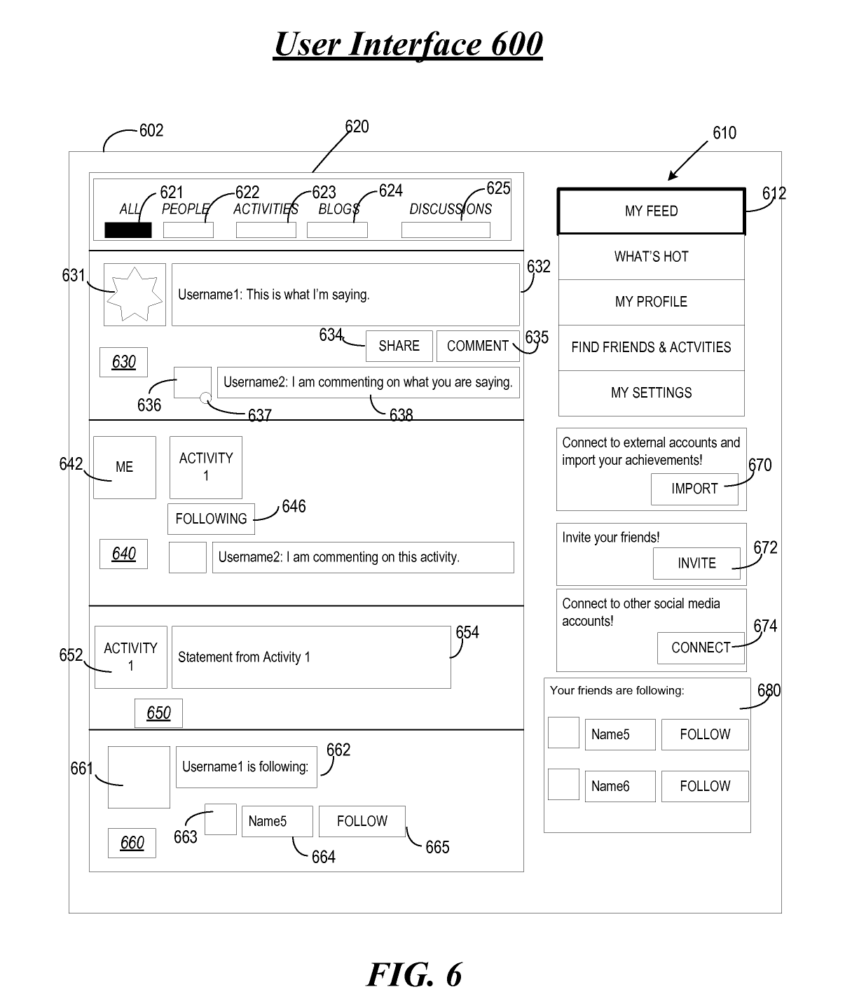

FIG. 6 illustrates an embodiment of a user interface 600 for a “My Feed” page that allows a user to view his feed 124. User interface (UI) 600 may be one UI provided by user interface 414. UI 600 may be presented within a window 602, which may be a window generated by application 112, application 134, or within a browser application, for example.

UI 600 may provide a selectable list 610 of pages to view, which may be the same as selectable list 510. As shown in FIG. 6, the “My Feed” page option 612 is selected, and is being displayed in UI 600.

In various embodiments, UI 600 may display a feed 124 for a user 130. UI 600 may also display additional options for enhancing a user experience or for adding information to a user profile 116. The selections of information displayed in UI 600 may be unique to that user, because the selection may be based on the user profile 116, which is very likely to be unique among all users of social environment 110.

In various embodiments, UI 600 may include a feed pane 620. Feed pane 620 may display items from the feed 124 of the viewing user. In an embodiment, feed pane 620 may display the items in a particular order, for example, chronologically with the newest item on top. Feed pane 620 may also provide options to view subsets of a feed, for example, with a “people” tab 622, an “activities” tab 623, a “blogs” tab 624, and a “discussions” tab 625. Selecting one of these tabs may change the display within feed pane 620 to only items that are contributed by other users, items that are contributed by activities, blog entries of followed users, and followed discussions, respectively. In FIG. 6, the “all” tab 621 is selected, causing UI 600 to display all feed items in feed pane 620.

Feed pane 620 may include different kinds of contributions. For example, section 630 includes a statement made by another user that the viewing user follows. Section 630 may include a registered user's avatar 631 and a statement box 632. Statement box 632 may include an identification of the registered user's user name, “Username1” in the current example, as well as the contribution of the registered user. Section 630 may further provide share button 634 and comment button 635. Share button 634, when selected by a control directive, allows the viewing user to add the statement in statement box 632 to his own feed, effectively sharing the statement with his own followers. Comment button 634, when selected by a control directive, allows the viewing user to write and share a comment on the statement in statement box 632.

A comment made by a registered user, after selecting comment button 634, may appear in a comment box 638, along with the commenting user's name, e.g. Username2 in the illustrated example. Additionally, the avatar 636 for the commenting user may be displayed next to comment box 638. In an embodiment, a follow switch 637 may be displayed on avatar 636 to allow the viewing user to follow, or stop following, the commenting user. Selecting follow switch 637 may cause the viewing user to start following the commenting user. Follow switch 637 may change visually to indicate the change from a “not following” state to a “following” state for the viewing user.

Section 640 may include a contribution from the viewing user. In this example, the contribution is that the viewing user is now following Activity 1. Section 640 may display an avatar 642 for the viewing user, and a representation 644 of Activity 1, e.g. a logo, image, graphic, trademark and so forth. Section 640 may also display a following button 646. Following button 646 may be similar to follow button 523 from UI 500, showing a following status rather than the not-following status shown by follow button 523. Section 640 may also show comments, similar to that in section 630, made by other users about Activity 1.

Section 650 may display a contribution from an activity. As activities may generally be representations of non-human entities, a contribution from an activity may be generated by a person on behalf of the activity, or may be automatically generated from various data sources. Regardless, an activity contribution may be analogous to a user contribution. Section 650 may display a representation 652 of Activity 1, e.g. a logo, image, graphic, trademark and so forth. Section 650 may display a statement box 654 in which the contribution from Activity 1 is displayed. If Activity 1 is a computer game, for example, a contribution may include news about an available update, links to reviews of the game, news about personnel involved with the game development, and so forth. The embodiments are not limited to these examples.

Section 660 may display information about what the viewing user's followed users are doing. In the illustrated example, Username1 is now following Name5. Section 660 may show an avatar 651 of Username1, with a statement 662 about the new event: “Username1 is following:”. Section 650 may also show a representation of the newly followed entity, e.g. an avatar 663 of Name5 and a name label 664. Section 660 may also provide a follow button 665, analogous to follow button 523, to allow the viewing user to easily begin following Name5 also.

While FIG. 6 shows some possible examples of what may appear in a viewing user's feed pane 620, the embodiments are not limited to these examples. As indicated, for example, by the other tabs (622-625), additional content may be displayed in the “all” tab 621.

UI 600 may also provide other ways for a viewing user to follow additional content and/or add to the user profile 116. For example, UI 600 may provide an import button 670. Import button 670 may allow the viewing user to identify external activity accounts 212 and link the external activity accounts 212 to the user profile 116. When the viewing user has imported external activity accounts 212, achievements from those external activities may appear in feed pane 620.

UI 600 may provide an invite button 672. Invite button 672 may allow the viewing user to invite others to join the social environment. Selecting invite button 672 with a control directive may open an entry user interface where the viewing user may enter email addresses, social network identities, or other identifying means for friends. An invitation may be sent to the identified friend(s), including a link to join the social environment.

UI 600 may display a “friends are following” pane 680 that may display entities 102 that the viewing user's followed users are themselves following. Pane 680 may also provide follow buttons to allow the viewing user to easily begin following the entities as well.

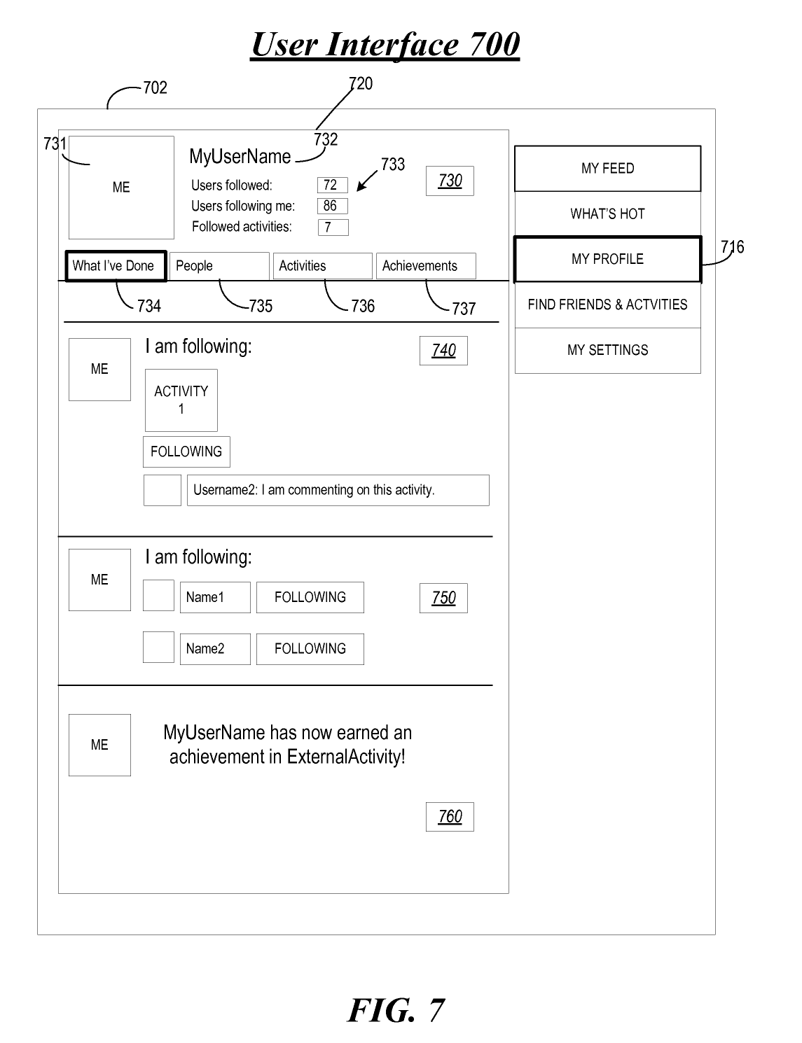

FIG. 7 illustrates an embodiment of a user interface 700 for a “My Profile” page that allows a user to view aspects of a user profile 116. User interface (UI) 700 may be one UI provided by user interface 414. UI 700 may be presented within a window 702, which may be a window generated by application 112, application 134, or within a browser application, for example.

UI 700 may provide a selectable list 710 of pages to view, which may be the same as selectable lists 510 and 610. As shown in FIG. 7, the “My Profile” option 616 is selected and is being displayed in UI 700.

In various embodiments, UI 700 may include a profile pane 720 in which aspects of a user's profile may be displayed. For example, profile pane 720 may include a header section 730. Header section 730 may display some information about the user for whom the profile is displayed (referred to herein as the profiled user). For example, header section 730 may include the profiled user's avatar 731, and the profiled user's name 732, e.g. MyUserName. Header section 730 may also include a summary 733 of, for example but without limitation, how many users the profiled user is following, how many users follow the profiled user, and how many activities the profiled user is following. Additional or other information about the profiled user may appear in header section 730, such as external activity achievements, a rank within social environment 110, or other information from the profiled user's profile 116.

Profile pane 720 may organize profile information, for example, into different tabbed pages, such as “what I've done” tab 734, “people” tab 735, “activities” tab 736, and “achievements” tab 737. In the illustrated example, the tabbed page corresponding to tab 734 is displayed.

The tabbed page corresponding to tab 735 may display a list of the people that the profiled user is following and/or is being followed by. The tabbed page corresponding to tab 736 may display a list of activities that the profiled user is following. The tabbed page corresponding to tab 737 may display a list of achievements that the profiled user has earned within social environment 110 and/or from an external activity environment 210.

The “what I've done” tabbed page may list contributions from the profiled user. Section 740 may show, for example, an activity that the profiled user recently began following, along with comments about that activity. Section 750 may show, for example, a list of other users that the profiled user has recently started following. Section 760 may show an achievement that the profiled user has recently earned in external activity environment 210. Additional contributions that may be displayed may include, for example and without limitation, blog posts, comments, statements, shared content, and so forth.

In various embodiments, it may be possible to view some or all of another user's profile. A user's name as displayed, for example, in section 750, or name label 664 in UI 600, may be a hyperlink to a profile page for that user. Selecting a user's name may cause a profile page substantially similar to UI 700 to open.

In one illustrative example, a social environment 110, 400 may be organized around the topic of computer gaming. In such an example, the registered users may typically be individuals who play, create, review or otherwise interact with computer games. The users may identify themselves to other users with a gaming persona, rather than an actual identity. For example, a user who plays online games using a player name “BadWolf” may choose to use “BadWolf” as their social environment username, so that other users who play with “BadWolf” may find him or her easily in the social environment.

The activities of such a computer gaming social environment may include specific computer game titles, and/or gaming platforms, such as console games, desktop/laptop computer games, online games, smart phone or tablet games, and so forth. Games in the social environment may generate content within the social environment, for example, by posting articles written about the game, news of upcoming updates or expansions, preview videos, demonstrations, walk-through descriptions, reviews and so forth.

Discussions may include game forums where various topics related to computer gaming are discussed. A user may comment in a discussion and then receive information from the discussion in their feed. Discussions may also include conversations generated from comments on content, such as on a post made by a game. A user may choose to follow the conversation, which will then appear on the user's feed when new comments are added to the conversation, including comments of other users that the user may not be following. The embodiments are not limited to these examples.

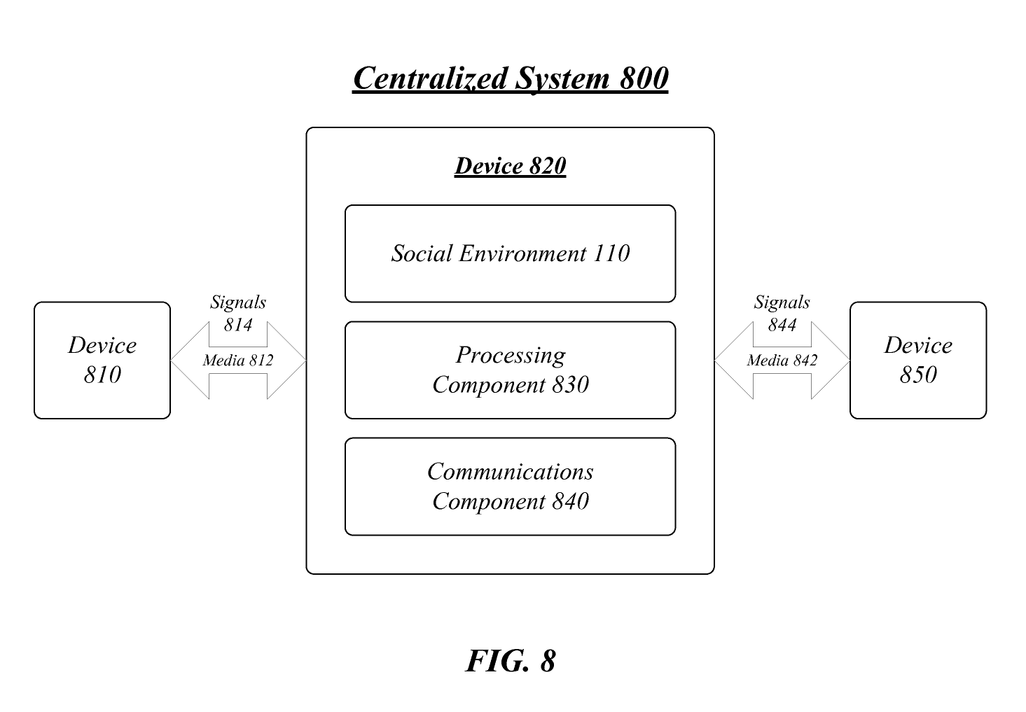

FIG. 8 illustrates a block diagram of a centralized system 800. The centralized system 800 may implement some or all of the structure and/or operations for the system 100 in a single computing entity, such as entirely within a single device 820.

The device 820 may comprise any electronic device capable of receiving, processing, and sending information for the system 100. Examples of an electronic device may include without limitation an ultra-mobile device, a mobile device, a personal digital assistant (PDA), a mobile computing device, a smart phone, a telephone, a digital telephone, a cellular telephone, ebook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, subscriber station, mobile subscriber center, radio network controller, router, hub, gateway, bridge, switch, machine, or combination thereof. The embodiments are not limited in this context.

The device 820 may execute processing operations or logic for the system 100 using a processing component 830. The processing component 830 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The device 820 may execute communications operations or logic for the system 100 using communications component 840. The communications component 840 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 840 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 812, 842 include wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

The device 820 may communicate with other devices 810, 850 over a communications media 812, 842, respectively, using communications signals 814, 844, respectively, via the communications component 840. The devices 810, 850 may be internal or external to the device 820 as desired for a given implementation.

The device 820 may, for example, implement some or all of the structure and/or operations for social environment 110. Users 130 using a device 810 or device 850 may send and receive media 812, 842 to and from social environment 110 via signals 814, 844 to enable a user to view and interact with social environment 110. Media 812, 842 may include, for example, web pages, videos, hyperlinks, and so forth.

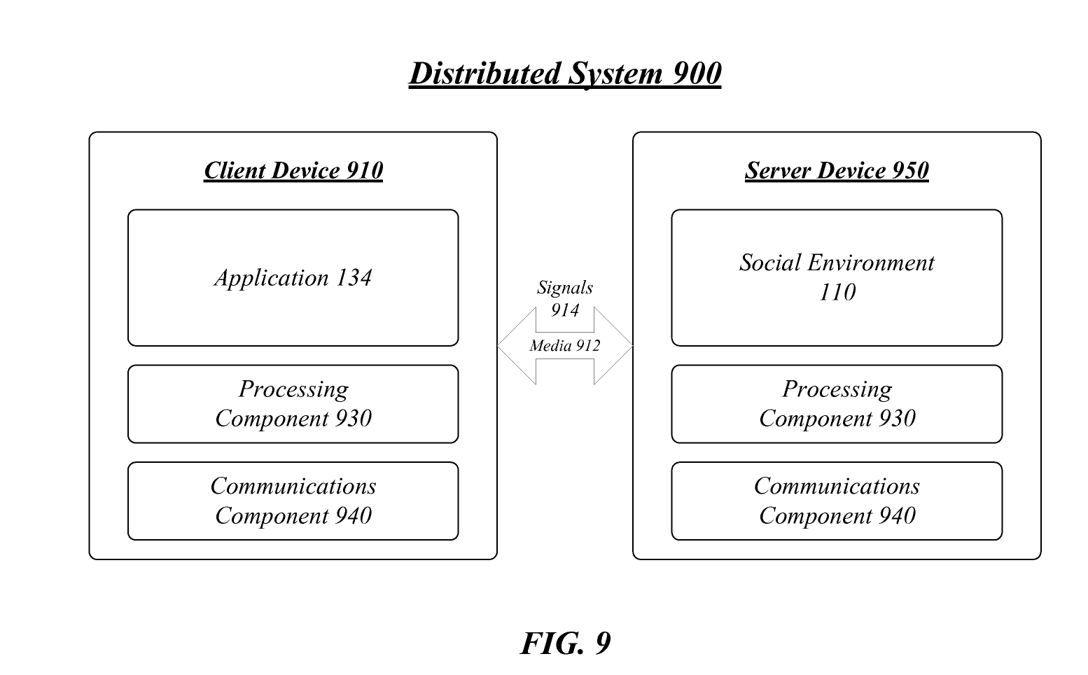

FIG. 9 illustrates a block diagram of a distributed system 900. The distributed system 900 may distribute portions of the structure and/or operations for the system 100 across multiple computing entities. Examples of distributed system 900 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

The distributed system 900 may comprise a client device 910 and a server device 950. In general, the client device 910 and the server device 950 may be the same or similar to the client device 820 as described with reference to FIG. 8. For instance, the client system 910 and the server system 950 may each comprise a processing component 930 and a communications component 940 which are the same or similar to the processing component 830 and the communications component 840, respectively, as described with reference to FIG. 8. In another example, the devices 910, 950 may communicate over a communications media 912 using communications signals 914 via the communications components 940.

The client device 910 may comprise or employ one or more client programs that operate to perform various methodologies in accordance with the described embodiments. In one embodiment, for example, the client device 910 may implement application 134 that may form a communication connection with social environment 110 and allow a user to view and interact with social environment 110.

The server device 950 may comprise or employ one or more server programs that operate to perform various methodologies in accordance with the described embodiments. In one embodiment, for example, the server device 950 may implement an social environment, such as social environment 110 or 400, and including application 112.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

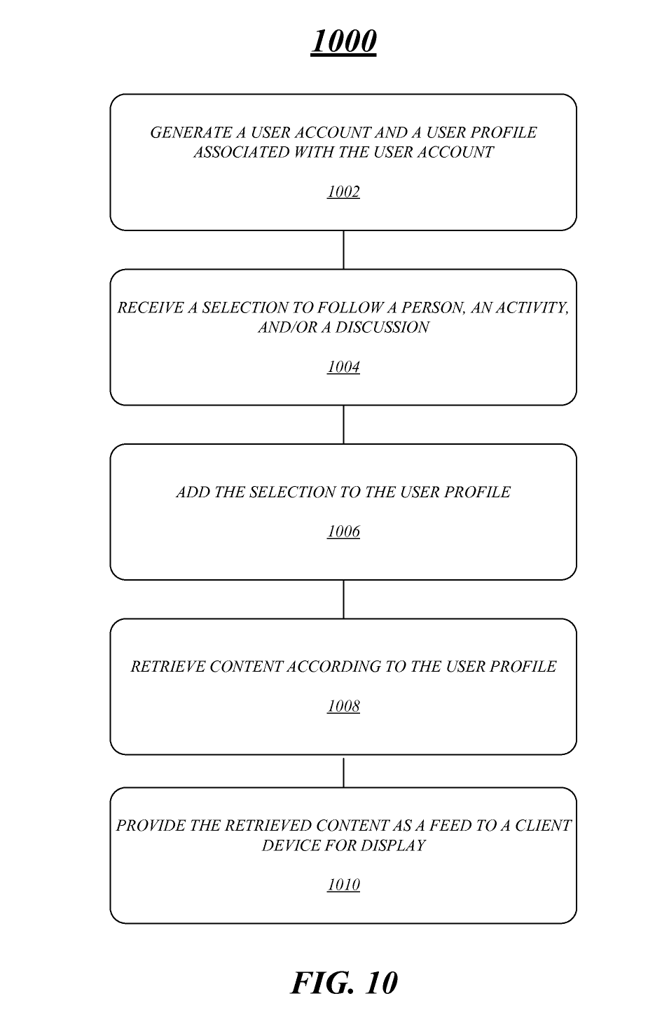

FIG. 10 illustrates one embodiment of a logic flow 1100. The logic flow 1000 may be representative of some or all of the operations executed by one or more embodiments described herein.

In the illustrated embodiment shown in FIG. 10, the logic flow 1000 may generate a user account and a user profile associated with the user account at block 1102. For example, account manager 412 may receive user-supplied information sufficient to generate a unique user account 114. Account manager 412 may also generate a user profile 116 that is linked to, or associated with, the user account 114 for the same user. When initially created, the user profile 116 may be empty, or may contain only information from the user account 114.

The logic flow 1000 may receive a selection to follow a person, an activity, and/or a discussion at block 1104. For example, social environment 110, 400 may cause a user interface 414 to be displayed on a client device 132, and may display contributions from a variety of social environment entities. A user 130 may, through control directives on a client device 132, select one or more of those social environment entities to follow. The entities may include, for example, persons, e.g. other users in the social environment, activities, and/or discussions.

The logic flow 1000 may add the selection to the user profile at block 1006. For example, account manager 412 may receive the selections of entities to follow for the user, and may add the selected entities to the user's profile 116. The user's profile 116 may, for example, include identifying information, e.g. a user ID, for the entities that the user has selected to follow, links to profiles of the entities that the user has selected to follow, directory paths or universal resource locators (URLs) of the entities that the user has selected to follow, and so forth.

The logic flow 1000 may retrieve content according to the user profile at block 1008. For example, feed generator 416 may identify a time period since the last feed 124 was generated, or a default time period if this is the first time a feed 124 is generated for this user. Feed generator 416 may examine the profiles of all of the entities being followed according to the user's profile 116. All contributions made by the followed entities within the time period may be collected and displayed to the user in a user interface 414 for displaying the feed 124, e.g. UI 600. In an embodiment, the feed 124 may be organized chronologically, by entity, by entity type, or some other logical presentation of the contributions.

The logic flow 1000 may provide the retrieved content according to a client device for display at block 1010. For example, social environment 110, 400 may provide feed 124 as content to be displayed within a web page displaying UI 600. The embodiments are not limited to this example. Feed 124 may be provided, for example and without limitation, hypertext markup language (HTML), extensible markup language (XML), or any other language or format suitable for being displayed by application 134 and/or a web browser application.

In various embodiments, when a user 130 makes a contribution, e.g. selects an entity to follow, writes a statement, writes a blog entry, writes a comment, or shares content, application 410 may add the contribution to social environment 110, 400, and may include that contribution in the user's feed and profile. Other users following user 130 may then see the contribution when they view their feeds.

In various embodiments, application 410 may link an external activity account 212 to a user profile 116. Feed generator 416 may retrieve activity information 214 from the external activity account, and add the activity information to the profile and feed for the user.

In various embodiments, feed generator 416 may retrieve content according to a person by retrieving from a user profile 116 for that person, at least one of: a comment made by the person; a status update made by the person; a topic being followed by the person; a blog entry written by the person; or an activity being followed by the person.

In various embodiments, feed generator 416 may retrieve content according to an activity 120 by retrieving at least one of: a comment made about the activity; a discussion about the activity; an article about the activity; a video about the activity; a review of the activity; a status update generated by the activity; or a blog entry referencing the activity.

In various embodiments, feed generator 416 may retrieve content according to a discussion 122 by retrieving a comment added to the discussion. In various embodiments, feed generator 416 may retrieve content from a data source 320 external to the topic-based social environment 110, 400.

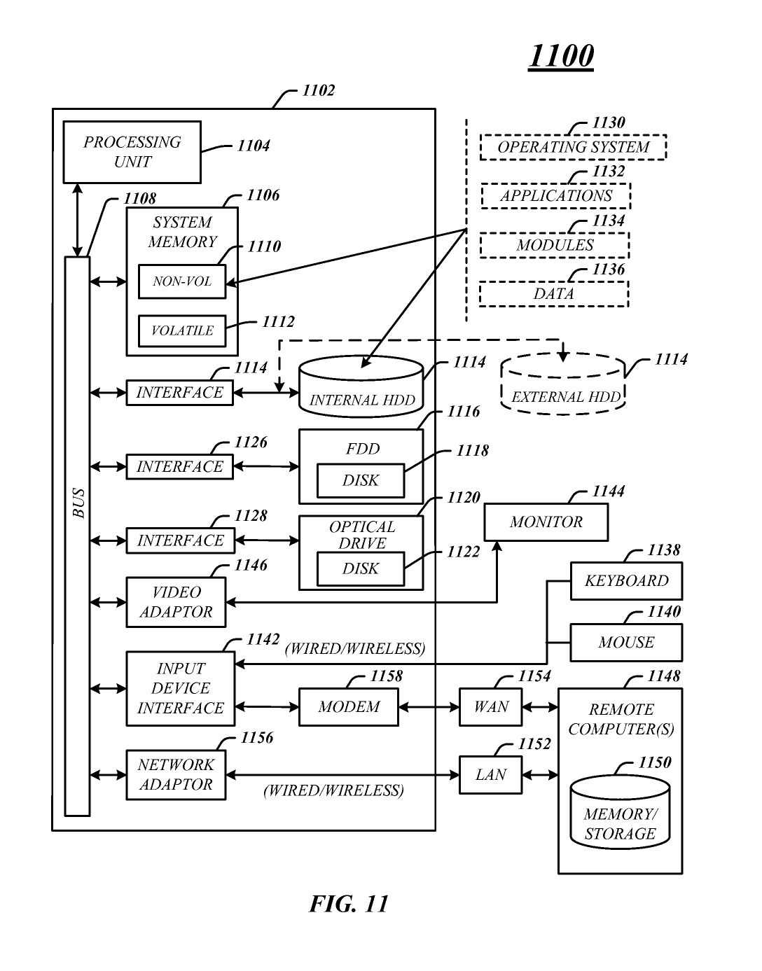

FIG. 11 illustrates an embodiment of an exemplary computing architecture 1100 suitable for implementing various embodiments as previously described. In one embodiment, the computing architecture 1100 may comprise or be implemented as part of an electronic device. Examples of an electronic device may include those described with reference to FIG. 8, among others. The embodiments are not limited in this context.

As used in this application, the terms “system” and “component” are intended to refer to a computer-related entity, either hardware, a combination of hardware and software, software, or software in execution, examples of which are provided by the exemplary computing architecture 1100. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1100 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1100.

As shown in FIG. 11, the computing architecture 1100 comprises a processing unit 1104, a system memory 1106 and a system bus 1108. The processing unit 1104 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 1104.

The system bus 1108 provides an interface for system components including, but not limited to, the system memory 1106 to the processing unit 1104. The system bus 1108 can be any of several types of bus structure that may further interconnect to a memory bus (with or without a memory controller), a peripheral bus, and a local bus using any of a variety of commercially available bus architectures. Interface adapters may connect to the system bus 1108 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 1100 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1106 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 11, the system memory 1106 can include non-volatile memory 1110 and/or volatile memory 1112. A basic input/output system (BIOS) can be stored in the non-volatile memory 1110.

The computer 1102 may include various types of computer-readable storage media in the form of one or more lower speed memory units, including an internal (or external) hard disk drive (HDD) 1114, a magnetic floppy disk drive (FDD) 1116 to read from or write to a removable magnetic disk 1118, and an optical disk drive 1120 to read from or write to a removable optical disk 1122 (e.g., a CD-ROM or DVD). The HDD 1114, FDD 1116 and optical disk drive 1120 can be connected to the system bus 1108 by a HDD interface 1124, an FDD interface 1126 and an optical drive interface 1128, respectively. The HDD interface 1124 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1110, 1112, including an operating system 1130, one or more application programs 1132, other program modules 1134, and program data 1136. In one embodiment, the one or more application programs 1132, other program modules 1134, and program data 1136 can include, for example, the various applications and/or components of the system 90.

A user can enter commands and information into the computer 1102 through one or more wire/wireless input devices, for example, a keyboard 1138 and a pointing device, such as a mouse 1140. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1104 through an input device interface 1142 that is coupled to the system bus 1108, but can be connected by other interfaces such as a parallel port, IEEE 1394 serial port, a game port, a USB port, an IR interface, and so forth.

A monitor 1144 or other type of display device is also connected to the system bus 1108 via an interface, such as a video adaptor 1146. The monitor 1144 may be internal or external to the computer 1102. In addition to the monitor 1144, a computer typically includes other peripheral output devices, such as speakers, printers, and so forth.

The computer 1102 may operate in a networked environment using logical connections via wire and/or wireless communications to one or more remote computers, such as a remote computer 1148. The remote computer 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wire/wireless connectivity to a local area network (LAN) 1152 and/or larger networks, for example, a wide area network (WAN) 1154. Such LAN and WAN networking environments are commonplace in offices and companies, and facilitate enterprise-wide computer networks, such as intranets, all of which may connect to a global communications network, for example, the Internet.

When used in a LAN networking environment, the computer 1102 is connected to the LAN 1152 through a wire and/or wireless communication network interface or adaptor 1156. The adaptor 1156 can facilitate wire and/or wireless communications to the LAN 1152, which may also include a wireless access point disposed thereon for communicating with the wireless functionality of the adaptor 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wire and/or wireless device, connects to the system bus 1108 via the input device interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

FIG. 13 illustrates a block diagram of an exemplary communications architecture 1300 suitable for implementing various embodiments as previously described. The communications architecture 1300 includes various common communications elements, such as a transmitter, receiver, transceiver, radio, network interface, baseband processor, antenna, amplifiers, filters, power supplies, and so forth. The embodiments, however, are not limited to implementation by the communications architecture 1300.

As shown in FIG. 13, the communications architecture 1300 comprises includes one or more clients 1302 and servers 1304. The clients 1302 may implement the client device 910. The servers 1304 may implement the server device 950. The clients 1302 and the servers 1304 are operatively connected to one or more respective client data stores 1308 and server data stores 1310 that can be employed to store information local to the respective clients 1302 and servers 1304, such as cookies and/or associated contextual information.

The clients 1302 and the servers 1304 may communicate information between each other using a communication framework 1306. The communications framework 1306 may implement any well-known communications techniques and protocols. The communications framework 1306 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 1306 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 1302 and the servers 1304. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. An apparatus, comprising:
a processing unit; and
social environment (SE) logic executing on the processing unit to:
generate a user account and a user profile associated with the user account within a topic-based social environment;
receive a selection to follow at least one of: a person, an activity, content, or a discussion;
add the selection to the user profile;
retrieve contributions according to the selection in the user profile; and
provide the retrieved contributions as a feed to a client device for display.

2. The apparatus of claim 1, comprising an achievement component executing on the processing unit to:
link an external activity account to the user profile;
retrieve activity information from the external activity account; and
add the activity information to the user profile.

3. The apparatus of claim 2, wherein the external activity account is different from the user account associated with the user profile.

4. The apparatus of claim 1, the SE logic to retrieve contributions according to a person by retrieving at least one of:
a comment made by the person;
a statement made by the person;
a topic being followed by the person;
a blog entry written by the person; or
an activity being followed by the person.

5. The apparatus of claim 1, the SE logic to retrieve contributions according to an activity by retrieving at least one of:
a comment made about the activity;
a discussion about the activity;
an article about the activity;
a video about the activity;
a review of the activity;
a statement generated by the activity; or
a blog entry referencing the activity.

6. The apparatus of claim 1, the SE logic to retrieve contributions according to a discussion by retrieving a comment added to the discussion.

7. The apparatus of claim 1, wherein content is related to the topic of the topic-based social environment, and comprises at least one of:
an article;
a video;
a podcast;
an audio recording; or
a blog post.

8. The apparatus of claim 7, the SE logic to retrieve content from a data source external to the topic-based social environment.

9. The apparatus of claim 1, wherein an activity is related to the topic of the topic-based social environment, and comprises a representation of at least one of:
a computer game;
a console game;
a hobby;
a sport;
a news topic;
a video product;
an audio product; or
a consumer product.

10. A computer-implemented method, comprising:
generating a user account and a user profile associated with the user account within a topic-based social environment;
receiving a selection to follow an entity comprising at least one of: a person, an activity, content, or a discussion;
adding the selection to the user profile;
retrieving contributions from followed entities according to the user profile; and
providing the retrieved contributions as a feed to a client device for display.

11. The computer-implemented method of claim 10, comprising:
receiving a contribution via the client device from a user having the user account; and
adding the contribution to the user profile for the user.

12. The computer-implemented method of claim 11, wherein receiving a contribution from the user comprises receiving at least one of:
a statement;
a comment;
a share selection; or
a follow selection.

13. The computer-implemented method of claim 10, comprising:
linking an external activity account to the user profile;
retrieving activity information from the external activity account; and
adding the activity information to the user profile.

14. The computer-implemented method of claim 10, wherein content is related to the topic of the topic-based social environment, and comprises at least one of: an article; a video; a podcast; an audio recording; or a blog post; and wherein retrieving contributions according to content comprises retrieving at least one of:
the content;
a comment about the content;
a follow of the content; or
a share of the content.

15. At least one computer-readable storage medium comprising instructions that, when executed, cause a system to:
receive a selection from a registered user within a topic-based social environment to follow an entity comprising at least one of: a person, an activity, content, or a discussion;
add the selection to a user profile of the registered user;
retrieve contributions according to the user profile; and
provide the retrieved contributions as a feed to a client device for display.

16. The computer-readable storage medium of claim 15, comprising instructions that when executed cause the system to:
receive a contribution via the client device from the registered user; and
add the contribution to the user profile for the registered user.

17. The computer-readable storage medium of claim 15, comprising instructions that when executed cause the system to:
link an external activity account to the user profile;
retrieve activity information from the external activity account; and
add the activity information to the user profile.

18. The computer-readable storage medium of claim 15, comprising instructions that when executed cause the system to:
provide a user profile for at least one of the user or a followed person to a client device for display.

19. The computer-readable storage medium of claim 15, comprising instructions that when executed cause the system to:
retrieve content from a data source external to the topic-based social environment.

20. The computer-readable storage medium of claim 15, comprising instructions that when executed cause the system to: generate new a user account and a new user profile associated with the new user account within the topic-based social environment from user information received from a user via a client device.
